(19) United States
(12) Patent Application Publication
(10) Pub. No.: US 2002/0114460 A1
(43) Pub. Date: Aug. 22, 2002

(54) Method of embedding a secondary signal in the bitstream of a primary signal

(76) Inventor: Petrus Henricus Cornelius Bentvelsen, Eindhoven (NL)

Correspondence Address: U.S. Philips Corporation, 580 White Plains Road, Tarrytown, NY, 10591, US

(21) Appl. No.: 10/078,975

(22) Filed: Feb. 19, 2002

(30) Foreign Application Priority Data
Feb. 19, 2001 (EP) 01200575.7

(51) Int. Cl. G06F 17/60; H04N 7/167; H04L 9/00; H04K 1/00

(52) U.S. Cl. 380/201; 705/57; 380/205

(57) ABSTRACT

The invention relates to a method of embedding a secondary signal of a secondary channel in the bitstream of a primary signal of a primary channel. For copy protection and digital rights management for recordable or rewritable data carriers it is required that a key can be written and rewritten in a hidden side channel, i.e. in the secondary channel. Therefore it is proposed according to the invention that the bitstream of the primary signal is distorted before outputting the bitstream of the primary signal such that the secondary signal is represented by a predetermined distortion. The invention relates further to a method for detecting a secondary signal embedded in the bitstream of a primary signal, to corresponding apparatuses and to a corresponding data carrier.

The invention relates to a method of embedding a secondary signal of a secondary channel in the bitstream of a primary signal of a primary channel. The invention relates further to a corresponding recording apparatus, to a method for detecting a secondary signal of a secondary channel embedded in the bitstream of a primary signal of a primary channel, to a corresponding replaying apparatus and to a data carrier for storing such signals.

WO 00/45381 discloses a record carrier having substantially parallel tracks, which exhibit first variations of a first physical parameter and second variations of a second physical parameter of the track. While the first variations represent information recorded on the record carrier, which information is recoverable by means of a controllable type of data processing, a modulation pattern of the second variations represents a code for controlling said type of data processing. This modulation pattern of the second variations can be regarded as a secondary signal of a secondary channel and is commonly called a radial pit wobble.

For copy protection and digital rights management for data transmitted over a transmission line or stored on a record carrier, in particular audio and/or video data or software transmitted via the internet, e.g. via superdistribution, or stored on a recordable or rewritable record carrier like a CD or DVD, it is required that a key of preferably at least 128 bits can be written and rewritten in a hidden side channel. Requirements on the side channel are among others that it can be read and written in home environment and that external access, i.e. read or write access, to the signal is difficult, i.e. that the signal is prevented from hacking. Further, it is required that the data channel cannot be copied in a disc image based on channel bits and that write and read actions can be done in a short time since the key must be available within seconds. The same requirements hold more or less for digital rights giving access to certain data. It is further preferred to increase the storage capacity of data carriers as much as possible.

The invention has therefore for its object to provide a method of embedding a secondary signal in the bitstream of a primary signal fulfilling the above-mentioned requirements with a reduced hardware needed. It is a further object to provide a corresponding method for detecting such a secondary signal, to provide corresponding apparatuses and to provide a data carrier for storing a primary signal having embedded therein a secondary signal.

This object is achieved by a method according to claim 1 wherein the bitstream of the primary signal is distorted before outputting the bitstream of the primary signal such that the secondary signal is represented by a predetermined distortion.

The invention is based on the idea to encode a secondary signal of a secondary channel, which may also be called side channel or hidden channel, in a primary signal of a primary channel comprising the original data to be transmitted or to be stored by controlled distortion which distortion may be detected in a Phase Locked Loop (PLL) circuit locked to the primary signal. According to the invention the pit and land pattern or the mark and space pattern, respectively, of the primary signal is deliberately distorted by the secondary signal at an encoding stage in a controlled way such that the PLL circuit of a detector can still accommodate for it. The error signals of the PLL circuit will then contain the information of the secondary signal of the secondary channel. To implement the invention in a recording apparatus or a replaying apparatus only a limited amount of additional hardware is required.

According to a preferred embodiment of the invention local phase errors are inserted in the bitstream of the primary signal. Thus, at least parts of the stream of lands and marks of the primary signal is displaced with a positive or negative phase error which can be detected by the PLL circuit of a detector. Thus, a part of the normal stream of lands and marks is cut out and placed back at slightly shifted position the shift being at maximum half of the channel clock period, preferably 20% to 50% of the channel clock period.

According to further preferred embodiments the absolute value of the phase error is chosen such that it is smaller than the channel clock period of the primary channel, preferably smaller than half of the channel clock period, preferably between 20% and 50% of the channel clock period. Further the phase errors do not lead to error flags, nor do they have a severe impact on the error correction capacity. For the detection of the secondary channel it is possible and preferable but not essential that the primary signal is error-free. For an error-free signal the absolute value of the phase error should preferably be smaller than half of the channel clock period. However, when a phase error is chosen larger than half of the channel clock period, in particular, a small phase error modulo the channel clock period, the secondary channel can be detected with equal quality with the difference that in the case that the absolute value of the phase error is larger than half of the channel clock period, the primary channel will have bit errors which can possibly be corrected. Still further, the phase error can be chosen such that the stream of pits and lands cannot be copied easily. Preferably a phase error should be chosen such that the stream of pits and lands cannot be copied easily using a sampling frequency is used which is a small integer multiple of the channel bit frequency of the primary channel.

In another preferred embodiment of the invention low frequency variations are introduced into the channel clock of the primary channel. Preferably the channel clock is modulated with a frequency within the bandwidth of the PLL circuit. A preferred modulation is a phase or frequency modulated sine wave. A sine wave modulation has an advantage that a sine wave has no higher harmonics, thereby making it possible to use the full bandwidth of the phase locked loop circuit. The distortion of this channel clock modulation is a low frequency variation of the clock such that the PLL circuit will follow smoothly while the frequency variation is high enough so that it does not influence the turn table motor control of a replaying apparatus. Preferably the modulation frequency is selected such that it is high enough to reach the required data rate which may be 128 user bits per second for embedding a key in the secondary channel. Further, it is selected such that no interference with the disc eccentricity and that no severe decrease of jitter margins appears.

In still a further embodiment of the invention the bitstream of the primary signal of the primary channel consists of a stream of bits for being recorded on a data carrier, in particular on an optical data carrier like a CD or a DVD, in the form of lands and marks. In principle the invention can be used in all recordable or rewritable optical storage media as well as in ROM-discs. The invention can further be used for the transmission of data via a transmission line, e.g. via the internet.

The object is further achieved by an apparatus for embedding a secondary signal of a secondary channel in the bitstream of a primary signal of a primary channel as claimed in claim 9 comprising distortion means and output means. Such an apparatus can be used in an apparatus for recording a primary signal of a primary channel of a record carrier as claimed in claim 11, in particular in a format generator for the recording of a master substrate in the stamper production for ROM-discs or in a rewritable/recordable drive for optical record carriers.

The object is further achieved by a method for detecting a secondary signal of a secondary channel embedded in the bitstream of a primary signal of a primary channel as claimed in claim 12 and by a corresponding apparatus as claimed in claim 14 comprising detection means and decoding means. Such an apparatus can be used in an apparatus for replaying data stored on a record carrier as claimed in claim 15. These comprise a PLL circuit eliminating the distortion according to the invention.

Still further the object is also achieved by a data carrier for storing a bitstream of a primary signal of a primary channel having embedded therein a secondary signal of a secondary channel as claimed in claim 16 which data carrier is preferably an optical record carrier like a CD or a DVD, e.g. a CD-ROM. It shall be understood that these apparatuses, this method and this data carrier can be developed further and can have further embodiments identical or similar to those which have been explained above with reference to the method of claim 1.

The invention will now be explained in more detail with reference to the drawing in which

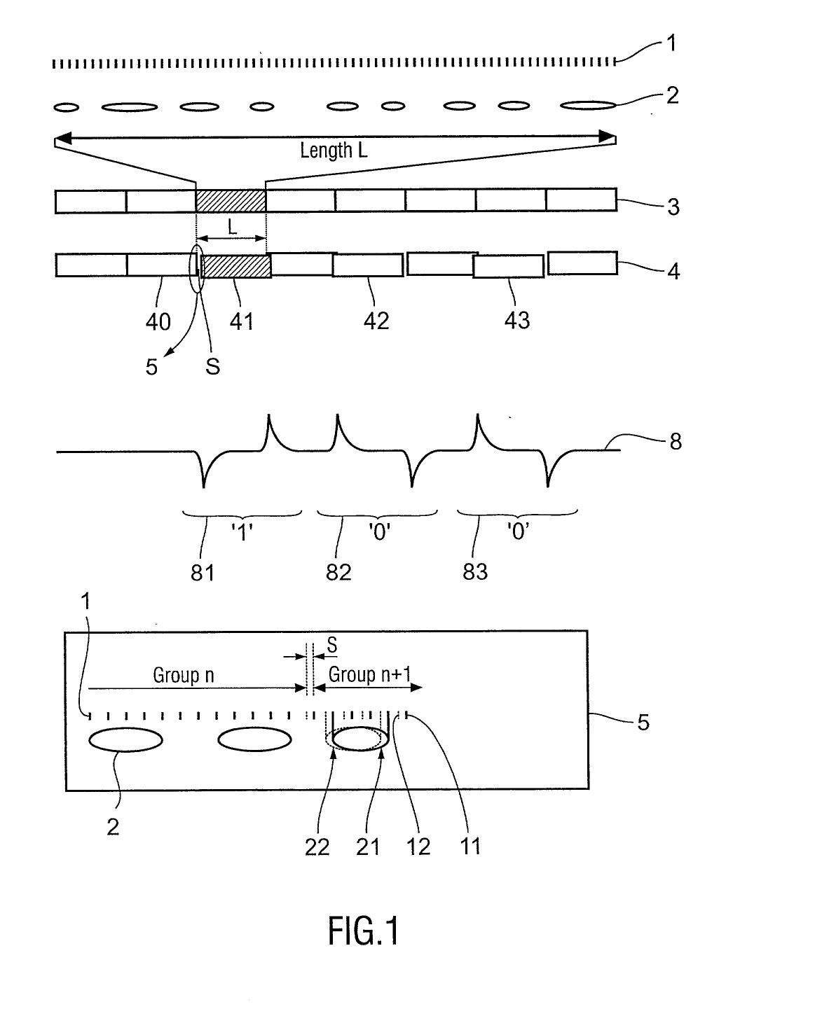

FIG. 1 shows a bitstream explaining a first embodiment of the invention,

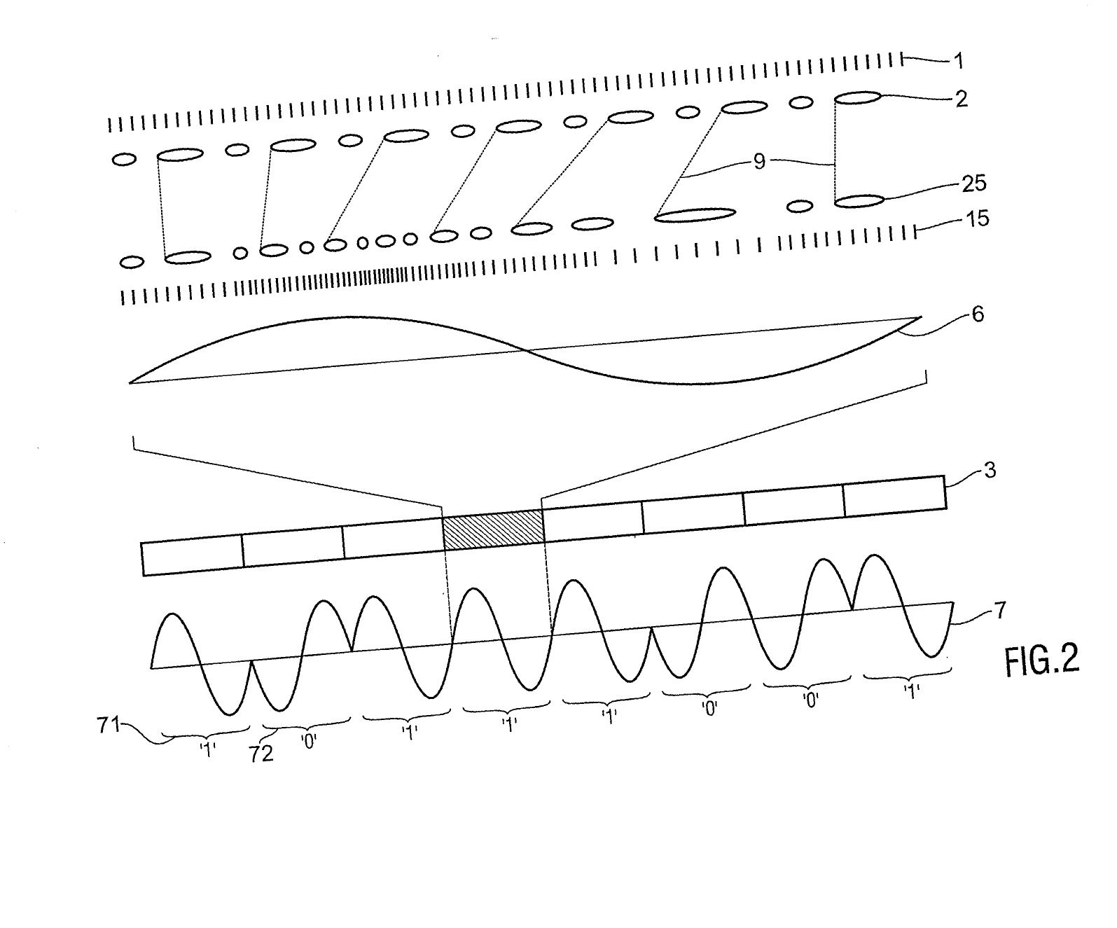

FIG. 2 shows a bitstream explaining a second embodiment of the invention,

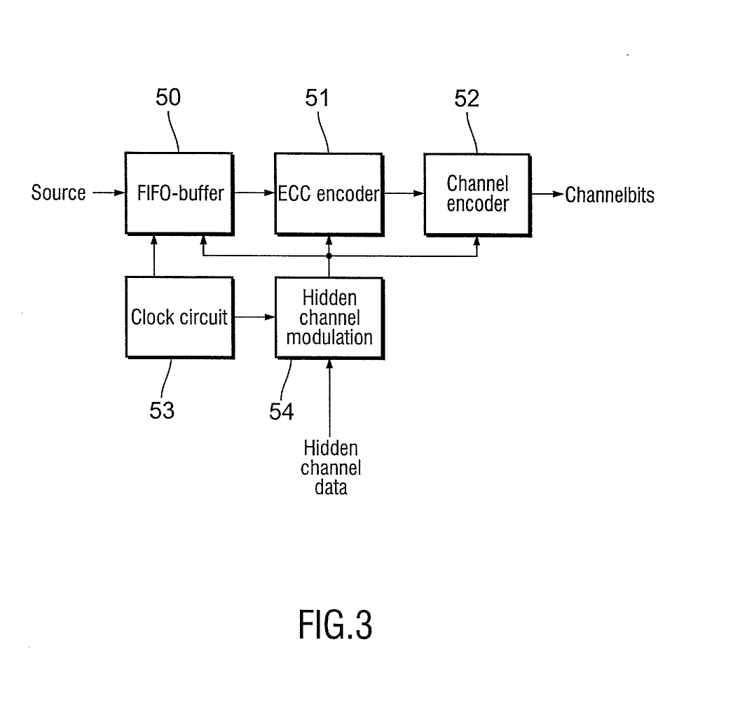

FIG. 3 shows a recording apparatus according to the invention,

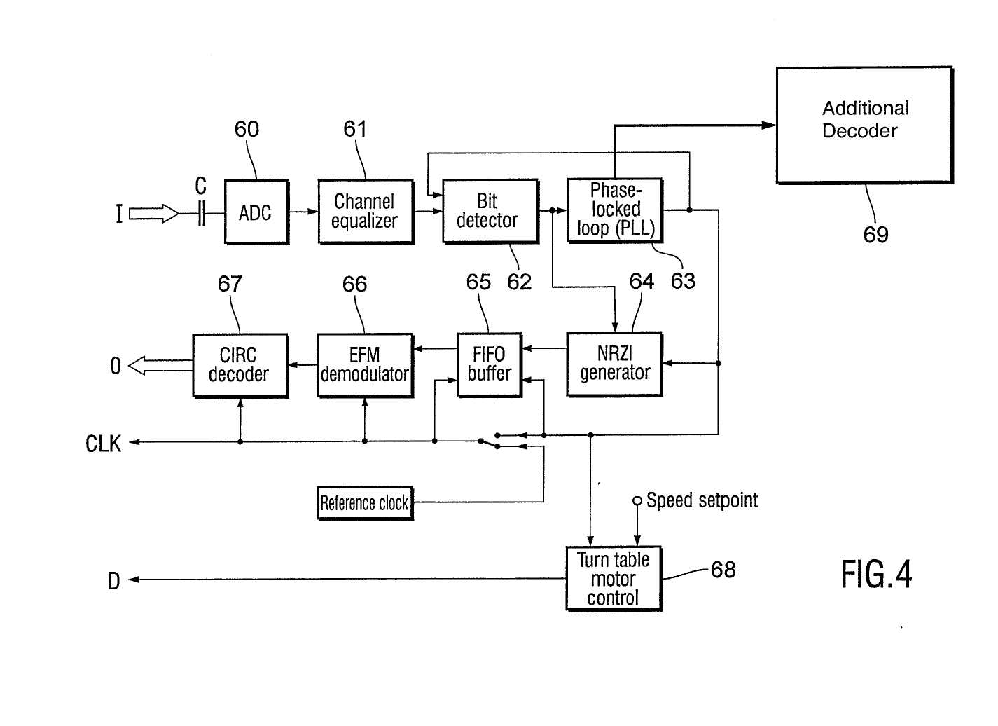

FIG. 4 shows a replaying apparatus according to the invention,

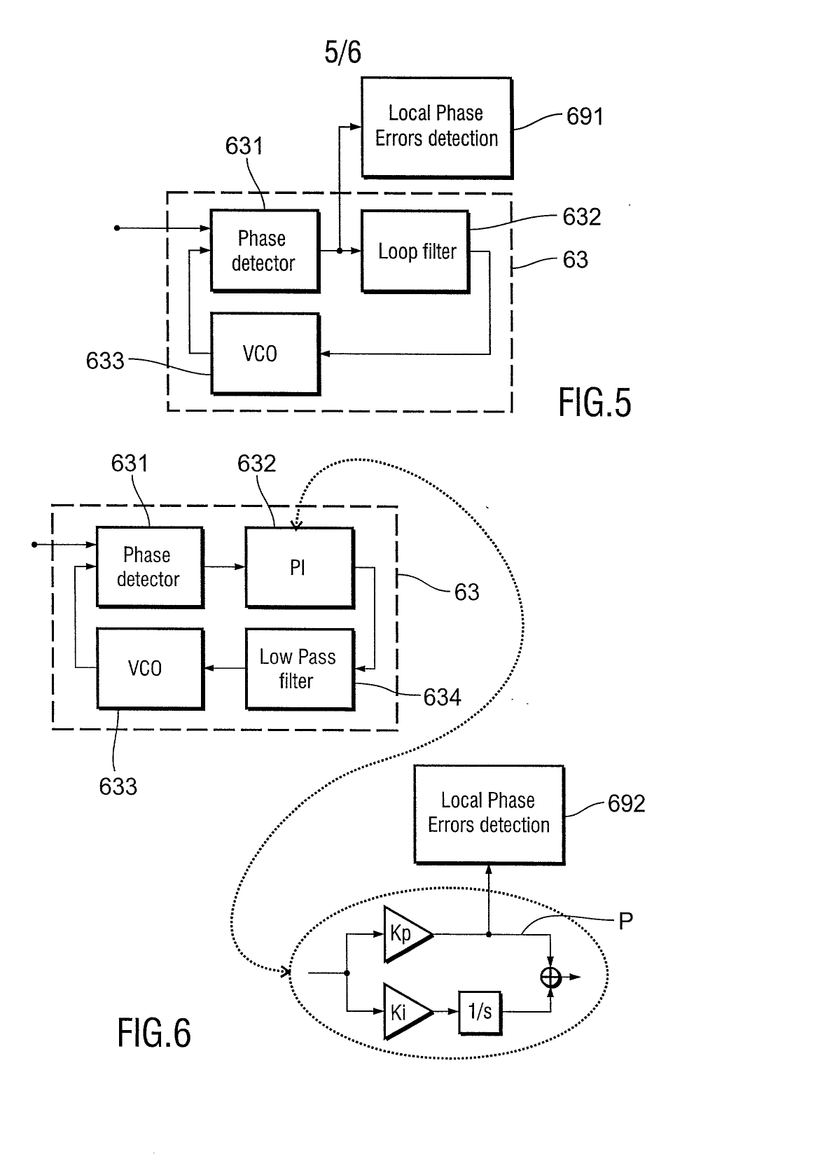

FIG. 5 shows a first embodiment of a phase locked loop circuit of a replaying apparatus,

FIG. 6 shows a second embodiment of a phase locked loop circuit of a replaying apparatus,

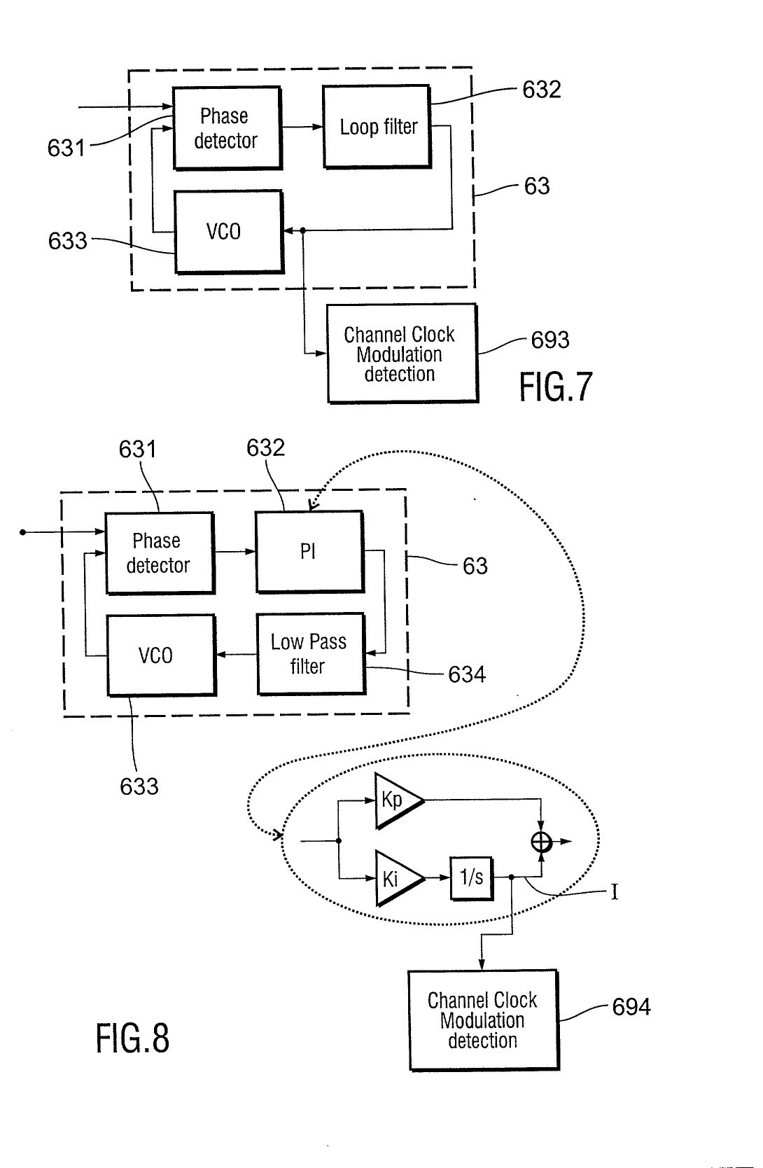

FIG. 7 shows a third embodiment of a phase locked loop circuit of a replaying apparatus,

FIG. 8 shows a forth embodiment of a phase locked loop circuit of a replaying apparatus.

FIG. 1 shows a channel clock signal 1 and a bit stream 2, i.e. a pit pattern, of a primary signal of a primary channel without a secondary channel over a length L. The normal stream of lands and marks of the primary channel without the secondary channel divided into portions of length L is also shown as a schematic representation 3. According to a first embodiment of the invention local phase errors are introduced into the bitstream 2 of the primary channel. This means that the stream of lands and marks over a length L is displaced with a positive or negative phase error, i.e. a part of the normal stream of lands and marks is cut out and placed back at a slightly shifted position. An example of a primary signal having embedded therein a secondary signal is denoted as 4. Therein the group n+1 (group 41) having a length L is shifted to the right relative to group n introducing a positive shift S, while groups 42 and 43 are shifted to the left introducing negative shifts.

Details of the shift S of group n+1, of the variation of the clock channel 1 and of the shift of the pit pattern 2 are shown in box 5. Therein the variations are indicated by dashed lines. It can be seen that the group 21 of pits is shifted to another position 22, and also the normal positions 11 of the channel clock are shifted to new positions 12. As can be further seen the shift S is small compared to the channel bit length.

As a result of this modulation the phase errors will always occur in pairs of one positive and one negative phase error. This can easily be seen in the signal 8 detected at a phase detector output of a PLL circuit versus time which corresponds to the primary signal 4 having embedded therein a secondary signal. It can be defined that a bit value “1” is represented by a positive phase error succeeded by a negative phase error—see portion 81 of signal 8 corresponding to group 41—while a bit value “0” is represented by a negative phase error succeeded by a positive phase error—see portions 82 and 83 of signal 8 corresponding to groups 42 and 43. The signal 8 and these bit values are detected by an appropriate decoder explained in more detail below.

The occurrence of pairs of phase errors is not essential to the invention, but it is used in a preferred implementation of the invention because over a longer period of time the total phase error will remain zero.

The phase error PE is preferably chosen such that it holds −0.5T<|PE|<0.50T, preferably 0.20T<|PE═<0.50T, where T is the channel clock period. Further, PE is chosen such that a sufficient signal-to-noise ratio in the secondary channel is obtained, so that phase errors do not lead to error flags and do not have a severe impact on the error correction capacity. The readout of the primary signal is maintained despite the distortions according to the invention.

FIG. 2 illustrates a second embodiment of the invention according to which low frequency variations are introduced into the channel clock of the primary channel. Again, for clarity reasons a channel clock signal 1 and a bitstream 2, i.e. a pit pattern, of a primary signal of a primary channel without a secondary channel are shown first. According to this embodiment of the invention the channel clock 15 of the primary channel is modulated with the secondary channel with a frequency within the PLL bandwidth. In the channel clock signal 15 shown in FIG. 2 a clock frequency of the primary channel is very high compared to the modulation frequency. 91 denotes an example of a pit pattern encoded according to this embodiment. The dashed lines 9 indicate the shift in position of the modulated pits of pit pattern 25 relative to the positions of the non-modulated pits of pit pattern 2.

In a detector explained in more detail below a regenerated clock frequency signal 6 versus time is detected, e.g. when a motor spindle of a CD replaying apparatus rotates at a constant linear velocity. A stream of lands and marks divided into several portions is denoted as 3. At a VCO (Voltage Controlled Oscillator) input of a PLL circuit of a detector a voltage signal 7 versus time can be measured. In this signal 7 the primary channel is modulated with a phase-modulated sine wave. This signal 7 can be divided into portions 71, 72 which can be interpreted as bit value “1” or bit value “0” depending on whether the positive or the negative sine half wave comes first or last in these portions 71, 72.

The detection of the modulation is done in a replaying apparatus which will be explained in more detail below by measuring a voltage signal 7 proportional to the channel clock frequency versus time t. The modulation frequency is selected such that the required data rate is reached, that no interference with disc eccentricity and no severe decrease of jitter margins appear. The voltage signal 7 can also be interpreted such that a positive sine wave represents a bit value “1” while a negative sine wave represents a bit value “0”.

In general, and for both embodiments holds, that the modulation or distortion can be done in may different ways and it can be determined in advance how a signal measured in the detector shall be interpreted. If, for example, the signal quality of a measured signal is poor, it can be chosen that a series of e.g. four positive sine waves in the embodiment shown in FIG. 2 represents a bit value “1”, while four negative sine waves represent a bit value “0”. The modulation can further be done as a frequency modulated sine wave where bit value “1” is represented by one or more sine waves having frequency f1, while bit value “0” is represented by one or more sine waves having frequency f0.

In FIG. 3 a simple block diagram of a recording apparatus according to the invention is shown. Conventionally the primary signal of the primary channel, i.e. the source bits, is encoded in a known and conventional way by an error correction code (ECC) encoder circuit 51 and thereafter by a channel encoder circuit 52. The channel bit output of the encoder circuit 52 is then normally lead to a write circuit for writing it to a record carriers. According to the invention a FIFO-buffer (First-In-First-Out) 50 is added into which the primary signal is clocked-in with the channel clock of the clock circuit 53. In parallel the channel clock of the primary signal is lead from the clock circuit 53 to a hidden channel encoder circuit 54 which is also provided with the secondary signal of the secondary channel, i.e. the hidden channel data. Said secondary signal is used to modulate the channel clock of the primary signal. The modulated channel clock is the output of the hidden channel encoder circuit 54 and is lead to the clock-out-input of the buffer 50, the ECC-encoder circuit 51 and the channel encoder circuit 52. The channel bits of the primary signal are then clocked-out at a clock rate dictated by the hidden channel encoder circuit 54.

A provision is taken that the average clock rate of the output clock of the buffer 50 is the same as the input clock provided from the clock circuit 53 to the buffer 50. Further, the buffer 50 should be chosen large enough such that the variations in the output clock rate do not lead to a buffer underrun or overflow. Finally, the primary signal having embedded therein a secondary signal as explained with reference to FIGS. 1 and 2 is outputted from the write circuit, i.e. is written to a record carrier. Alternatively, instead of a write circuit for writing the output signal to a record carrier a transmission circuit could be used for transmitting the output data over a transmission line.

According to the invention the hidden channel encoder circuit 54 and the FIFO-buffer 50 are added to a conventional recording apparatus as distortion means for the creation of the hidden channel. In a format generator for mastering of ROM-discs the clock circuit 53 will generate a clock signal for the encoder circuits and the control of the mastering turn table. In a disc recorder the clock circuit 53 will derive a clock from the format of the disc, e.g. from a groove wobble.

In principle the invention can be applied to all codewords of the primary signal. If the distortion is designed such that it has no impact on error correction capability, it could be used as a hidden channel parallel to the primary channel on a whole data carrier. Another possibility is to locate the distortions in a specific file or a certain location on the data carrier.

FIG. 4 shows a block diagram of a replaying apparatus according to the invention. The input signal I read from a data carrier, e.g. a CD, is first inputted to a front-end analog-to-digital converter 60. The apparatus comprises further a channel equalizer 61, a bit detector 62, a phase locked loop (PLL) circuit 63, a NRZI (Non-Return to Zero Invert) generator 64, a FIFO buffer 65, an EFM (Eight-to-Fourteen Modulation) demodulator 66 and a CIRC decoder 67 which outputs a clocked digital data signal 0. Further a turn table motor control 68 connected to a driving voltage D is provided. These elements and the function thereof are widely known and used in a typical layout of a replaying apparatus and are therefore not further explained herein.

Connected to the phase locked loop circuit 63 according to the invention an additional decoder 69 is provided. Therein the distortion of the bitstream of the primary signal distorted by the secondary signal is detected and the secondary signal is decoded therefrom. This will be explained in more detail with reference to FIGS. 5 and 6.

FIG. 5 shows a first embodiment of a PLL circuit 63 together with a detector 691 according to the invention. The PLL circuit 63 typically comprises a phase detector 631, a loop filter 632 and a voltage controlled oscillator 633. The PLL circuit 63 is designed to recover a clock signal from the primary signal data pattern on the disc, and it accommodates for distortions in the primary signal, such as velocity variations.

If according to the invention a secondary signal is embedded in the primary signal by a predetermined distortion of at least parts of the bitstream of the primary signal as explained above with reference to FIG. 1 by use of the additional detector these distortions can be detected and decoded into the secondary signal. If local phase errors are inserted in the bitstream of the primary signal, i.e. if the stream of lands and marks of the primary signal is displaced with a positive or negative phase error, these errors can be detected at the output of the phase detector 631 as indicated by the detector 691.

In an alternative embodiment of a PLL circuit 63 shown in FIG. 6 the PLL circuit 63 comprises further a low pass filter 634. In such an embodiment local phase errors can be detected in the proportional term P of a PI control circuit 632 as indicated by the detector 692. In both embodiments of FIG. 5 and 6 the phase errors in the stream of pits and lands lead to an error signal in the PLL circuit that can be seen at both locations as indicated by detectors 691 and 692.

If, as another alternative, a channel clock modulation is used for the distortion of the bitstream of the primary signal as explained above with reference to FIG. 2, i.e. for introducing low-frequency variations into the channel clock of the primary channel, the arrangement as shown in FIG. 7 or 8 will be used for the detection. The channel clock modulation can then be detected at the output of the loop filter 632 as indicated by detector 693. In an alternative embodiment shown in FIG. 8 the channel clock modulation can also be detected at the integrating term I of a PI control circuit 632 of the PLL circuits 63 as indicated by detector 694. The detected signal represents then a voltage which is proportional with the clock frequency of the primary signal. In an alternative embodiment the FIFO buffer 65, depicted in FIG. 4 is used. The indication of the degree of filling of this buffer can be used for detecting the channel clock modulation.

It shall be understood that the invention is not limited to the above described embodiments. There are further embodiments and several variations of the embodiments as shown, in particular the arrangement and the development of the elements of the apparatuses can also be different.

1. Method of embedding a secondary signal of a secondary channel in the bitstream of a primary signal of a primary channel, wherein the bitstream of the primary signal is distorted before outputting the bitstream of the primary signal such that the secondary signal is represented by a predetermined distortion.

2. Method according to claim 1, wherein local phase errors are inserted in the bitstream of the primary signal.

3. Method according to claim 2, wherein the absolute value of the phase error is chosen such that it is smaller than the channel clock period of the primary channel, preferably smaller than half of the channel clock period, preferably between 20% and 50% of the channel clock period.

4. Method according to claim 1, wherein low frequency variations are introduced into the channel clock of the primary channel.

5. Method according to claim 4, wherein the channel clock of the primary channel is modulated within the bandwidth of a phase locked loop circuit locked to the primary signal for synchronization, the channel clock preferably being modulated with a phase or frequency modulated sine wave.

6. Method according to claim 1, wherein the bitstream of the primary signal of the primary channel consists of a stream of bits for being recorded on a data carrier, in particular on an optical data carrier like a CD or a DVD, in the form of lands and marks.

7. Method according to claim 1, wherein the secondary signal comprises a copy protection key or a digital right.

8. Apparatus for embedding a secondary signal of a secondary channel in the bitstream of a primary signal of a primary channel, comprising:
distortion means for distorting the bitstream of the primary signal such that the secondary signal is represented by a predetermined distortion, and
output means for outputting the bitstream of the primary signal.

9. Apparatus according to claim 8, wherein the distortion means comprises
a buffer for buffering the bitstream of the primary signal and
an encoder for generating a distortion signal and modulating the buffered bitstream of the primary signal before inputting it to the output means.

10. Apparatus for recording a primary signal of a primary channel on a record carrier comprising an apparatus for embedding a secondary signal of a secondary channel in the bitstream of a primary signal of a primary channel according to claim 8.

11. Method for detecting a secondary signal of a secondary channel embedded in the bitstream of a primary signal of a primary channel, the secondary signal being represented by a predetermined distortion of the bitstream of the primary signal, wherein the distortion of the bitstream is detected and wherein the secondary signal is decoded from the distortion.

12. Method according to claim 11, wherein the distortion is detected in a phase locked loop circuit.

13. Apparatus for detecting a secondary signal of a secondary channel embedded in the bitstream of a primary signal of a primary channel, the secondary signal being represented by a predetermined distortion of the bitstream of the primary signal, comprising detection means for detecting the distortion of the bitstream, and decoding means for decoding the secondary signal from the distortion.

14. Apparatus for replaying data stored on a record carrier comprising an apparatus for detecting a secondary signal of a secondary channel embedded in the bitstream of a primary signal of a primary channel according to claim 13.

15. Data carrier for storing a bitstream of a primary signal of a primary channel having embedded therein a secondary channel, the bitstream of the primary signal being distorted before storing such that the secondary signal is represented by a predetermined distortion.
